(19) United States
(12) Patent Application Publication
(10) Pub. No.: US 2009/0079763 A1
(43) Pub. Date: Mar. 26, 2009

(54) RENDERING PROCESSING DEVICE AND ITS METHOD, PROGRAM, AND STORAGE MEDIUM

(75) Inventor: Shinya Takeichi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/173,167

(22) Filed: Jul. 15, 2008

(30) Foreign Application Priority Data
Sep. 20, 2007 (JP) 2007-244446

(51) Int. Cl. G06T 1/00; G09G 5/00

(52) U.S. Cl. 345/630; 345/522

(57) ABSTRACT

A rendering processing device which performs rendering processes of a plurality of inputted rendering process commands, categorizes the plurality of rendering process commands into a plurality of rendering command groups, assigns computation resources in order to execute rendering process commands for each of the plurality of rendering command groups, generates images by performing rendering processes based on the rendering process commands included in the rendering command groups, using the computation resources assigned, stores the images generated for each of the plurality of rendering command groups in a memory, and composites the images stored in the memory for each of the rendering command groups, wherein more computational resources are assigned to the rendering command group with higher priority.

### BACKGROUND OF THE INVENTION

1. Field of the Invention

The present invention relates to a rendering processing device and its method, program and storage medium.

2. Description of the Related Art

Conventionally, a rendering algorithm called Painter's algorithm is widely known in which a series of rendering process commands are inputted and sequential rendering process is performed. Painter's algorithm generates one frame of a still image by performing overwrite process in the order of rendering process command input in relation to a single rendering buffer. In order to achieve display of dynamic changes such as animation, repeated input of a series of rendering process commands following parameter changes is performed.

The outline of Painter's algorithm is explained with reference to FIGS. 13A and 13B. FIGS. 13A and 13B are schematic diagrams which explain Painter's algorithm.

FIG. 13A illustrates an example of an inputted series of rendering process commands. FIG. 13A shows an example of rendering command inputted in the sequence of a polygon rendering process command, an ellipse rendering process command, a moving image rendering process command, and a rectangle rendering process command.

FIG. 13B shows performing a rendering process when rendering processing commands were inputted in the sequence shown in FIG. 13A. According to Painter's algorithm, a polygon rendering process command is received first (step 1301) and rendered (step 1302). Subsequently, a moving image rendering process command is received (step 1305), which is then rendered (step 1306). Lastly, a rectangle rendering process command is received (step 1307) and rendered (1308). With these steps 1301 to 1308, rendering of a single frame is completed.

On the other hand, a technique of mixing and compositing moving images and graphics with a computer and displaying the resultant image is known. Generally, moving images and graphics exist as separate entities; the inputted moving images are converted and superimposed with the graphics on top, and displayed on the monitor (refer to Japanese patent laid-open 2005-321481).

However, when a series of rendering process commands is inputted, and painter's algorithm is performed as is during rendering process, there have been cases where occurrence of so-called “drop frame” takes place when time-consuming processes are included in the rendering process commands. For example, the displayed frame rate drops below the moving image frame rate, resulting in a “drop frame”. This is explained with reference to FIGS. 14A and 14B. FIGS. 14A and 14B are schematic diagrams illustrating problems associated with Painter's algorithm.

FIG. 14A is a schematic diagram which explains occurrence of a “drop frame”. A moving image is played back at a given frame rate, where the time for a single frame is ΔT1 and the time required by the rendering device for rendering a single frame is ΔT2. When ΔT2>ΔT1, frame N displayed at time t0 is followed by frame N+2, raising a possibility of dropping frame N+1.

Further, there have been cases where important graphics animation contained in the contents is not properly displayed. FIG. 14B is a schematic diagram that explains a situation where the effect of animation is not adequately displayed.

In FIG. 14B, the graphical animation is set to repeatedly blink every ΔT1. When ΔT2>ΔT1, where ΔT2 equals the time required by the rendering device for rendering a single frame, the graphics displayed at time T0 is also displayed in the subsequent rendering timing of T0+ΔT2. However, the graphics must be hidden within the time frame of ΔT2, leading to occurrence of what is practically a “drop frame”.

These occurrences stem from the computation resources of the rendering processing device being inadequate for performing the requested rendering process.

### SUMMARY OF THE INVENTION

The present invention is conceived in view of the above-mentioned problems, and has as its objective to provide a technique which allows performing high quality rendering processes, preventing “drop frame” in rendering by rendering process commands with high priority even with limited computation resources. Further features of the present invention will become apparent from the following description of exemplary embodiments (with reference to the attached drawings).

According to one aspect of the present invention, a rendering processing device which performs rendering processes of a plurality of inputted rendering process commands, includes:

a categorizing unit adapted to categorize the plurality of rendering process commands into a plurality of rendering command groups;

an assigning unit adapted to assign computation resources in order to execute rendering process commands for each of the plurality of rendering command groups;

a generation unit adapted to generate images by performing rendering processes based on the rendering process commands included in the rendering command groups, using the computation resources assigned by the assigning unit;

a storage unit adapted to store the images generated by the generation unit for each of the plurality of rendering command groups in a memory; and

a compositing unit adapted to composite the images stored in the memory for each of the rendering command groups,

wherein the assigning unit assigns more computational resources to the rendering command group with higher priority.

According to another aspect of the present invention, a rendering processing device which performs rendering processes of a plurality of inputted rendering process commands, includes:

an assigning unit adapted to assign computation resources to each of the plurality of rendering process commands in order to execute rendering process commands;

a generation unit adapted to generate images by performing rendering processes based on the rendering process commands, using the computation resources assigned by the assigning unit;

a storage unit adapted to store the images generated by the generation unit for each of the plurality of rendering process commands in a memory unit; and

a compositing unit adapted to composite the images stored in the memory unit for each of the rendering process commands,

wherein the assigning unit assigns more computational resources to the rendering process command with higher priority.

According to still another aspect of the present invention, a rendering process method of a rendering processing device which performs rendering processes of a plurality of inputted rendering process commands, includes the steps of:

categorizing the plurality of rendering process commands into a plurality of rendering command groups;

assigning computation resources in order to execute rendering process commands for each of the plurality of rendering command groups;

generating images by performing rendering processes based on the rendering process commands included in the rendering command groups, using the computation resources assigned in the step of assigning; storing the images generated in the step of generating for each of the plurality of rendering command groups in a memory unit; and

compositing the images stored in the memory unit for each of the rendering command groups,

wherein more computational resources are assigned to the rendering command group with higher priority in the step of assigning.

Further features of the present invention will become apparent from the following description of exemplary embodiments (with reference to the attached drawings).

### BRIEF DESCRIPTION OF THE DRAWINGS

FIG. 1 is a block diagram which explains the hardware composition of the rendering processing device.

FIG. 2 is a block diagram indicating the functional composition of the rendering processing device.

FIG. 3 is a flowchart showing a process flow of the rendering processing device.

FIGS. 4A, 4B and 4C are schematic diagrams explaining inputted rendering process commands and their corresponding processes.

FIG. 5 is a flowchart indicating a flow of a series of processes in each individual rendering process command group.

FIG. 6 is a schematic diagram indicating the procedure of compositing a rendering buffer.

FIG. 7 is a flowchart showing a process flow of assigning CPU time to rendering process command units.

FIG. 8 is a schematic diagram explaining the processes taking place in steps S701 to S703 shown in FIG. 7.

FIG. 9 is a schematic diagram explaining a method of increasing assignment of CPU utilization.

FIGS. 10A, 10B and 10C are schematic diagrams explaining the effect according to the composition of the present embodiment.

FIGS. 11A and 11B are schematic diagrams illustrating an example of rendering process commands and rendering process command units.

FIGS. 12A and 12B are schematic examples illustrating assignment of CPU utilization for each rendering process command unit.

FIGS. 13A and 13B are schematic diagrams explaining about Painter's algorithm.

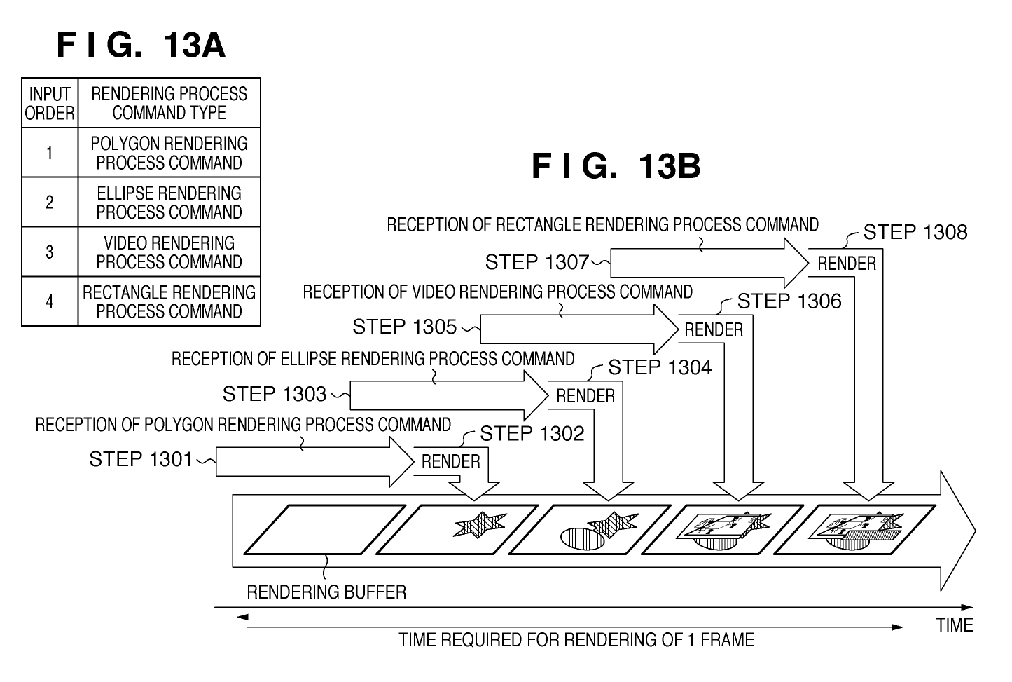

FIGS. 14A and 14B are schematic diagrams explain problems of Painter's algorithm.

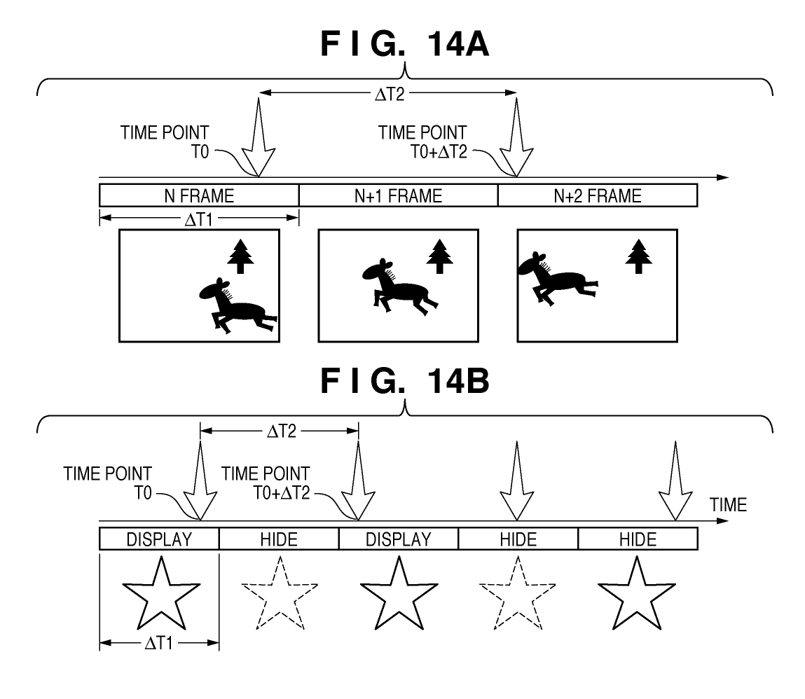

### DESCRIPTION OF THE EMBODIMENTS

From hereon, embodiments for the present invention will be explained with reference to the attached figures. However, the compositional elements disclosed in the embodiments are only exemplary, and is not intended to limit the scope of the invention in any way. Further, all possible combinations of the features explained in the embodiments are not necessarily essential for the solving means of the invention.

### First Embodiment

A first embodiment will be explained below with reference to figures.

[Hardware Composition]

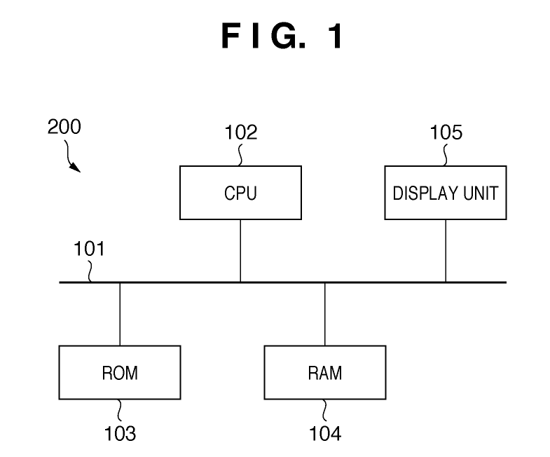

First off, the hardware composition of a rendering processing device 200 according to the present invention will be explained with reference to FIG. 1. FIG. 1 is a block diagram which explains the hardware composition of a rendering processing device.

In FIG. 1, a CPU 102 performs and controls each of the functions that is provided in the rendering processing device 200. A ROM 103 is a read-only memory, in which programs and various parameters that need not be modified are stored. A RAM 104 is a writable memory, comprised of SDRAM, DRAM, etc., and temporarily stores programs and data supplied from an external device and such.

A display unit 105 outputs rendered display screens by the programs to a display. A BUS 101 is a system BUS, and connects the CPU 102, ROM 103, RAM 104, and the display unit 105.

Note that it is also possible to comprise the present invention using software that performs equivalent functions to each of the devices mentioned above, instead of using hardware devices.

The present embodiment illustrates an example where a program comprising the invention of the present embodiment is stored beforehand, and this program is structured to be part of a memory map and is directly run by the CPU 102 directly perform. However, the present invention is not limited to this. For example, it is also possible to have the program of the present embodiment installed in the ROM 103 to be loaded to RAM 104 every time the program is operated.

Further, although the present embodiment describes an arrangement where the rendering processing device 200 of the present embodiment is a single device for the sake of convenience, a different arrangement in which resources are spread across a plurality of devices can also be used. For example, storage and computation resources can be distributed over a plurality of devices. Likewise, it is possible to distribute resources over each of virtual structural elements within the rendering processing device 200.

[Functional Composition]

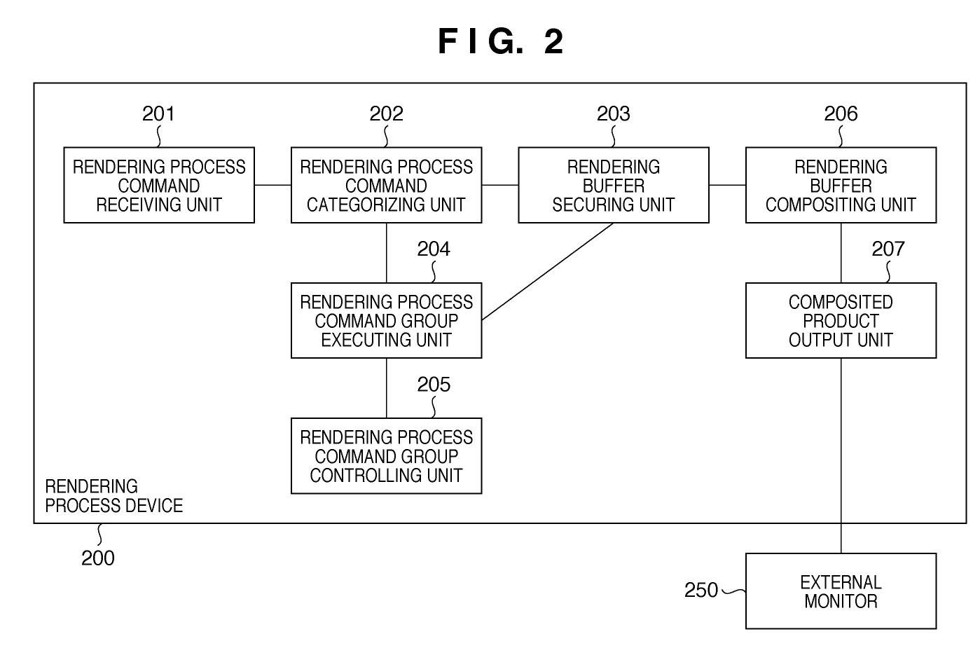

Next, functional composition of the rendering processing device 200 of the present embodiment will be explained with FIG. 2. FIG. 2 is a block diagram indicating the functional composition of the rendering processing device. As shown in FIG. 2, the rendering processing device 200 comprises the following functional blocks:

A rendering process command receiving unit 201 which receives rendering process commands called by program execution.

A rendering process command categorizing unit 202 which categorizes received rendering process commands and generates a plurality of rendering process command groups.

A rendering buffer securing unit 203 which secures rendering buffer in the RAM 104 for each of the generated rendering process command groups.

A rendering process command group executing unit 204 which executes the rendering process command groups and executes rendering process to the rendering buffer.

A rendering process command group controlling unit 205 which controls rendering process groups according to their priorities.

A rendering buffer compositing unit 206 which composites the rendering buffer comprised of a plurality of groups into a single entity.

A composited product output unit 207 which outputs the product of the composite to an external monitor.

[Overall Process]

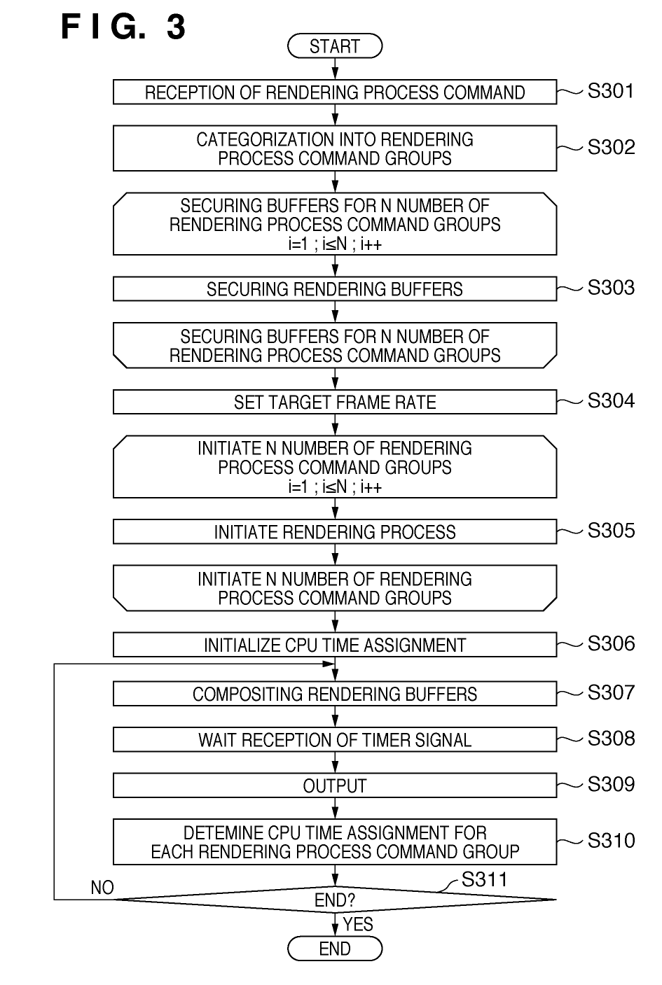

Next, the process executed by the rendering processing device 200 of the present embodiment will be explained with reference to FIG. 3. FIG. 3 is a flowchart showing a process flow of the rendering processing device 200. The rendering processing device 200 sequentially receives a rendering process command of video (moving image) data (moving image rendering process command) and a rendering process command of graphics data (graphics rendering process command). A case will be explained in which the priority for video rendering command is set high in order to prevent “drop frames” in video playback. The processes in each of the steps explained below are executed based on the control by the CPU 102. Note that a still image rendering process command which renders a still image, can also be inputted into the rendering processing device 200. Further, the graphics rendering process command can include an animation process, which changes the graphics with time.

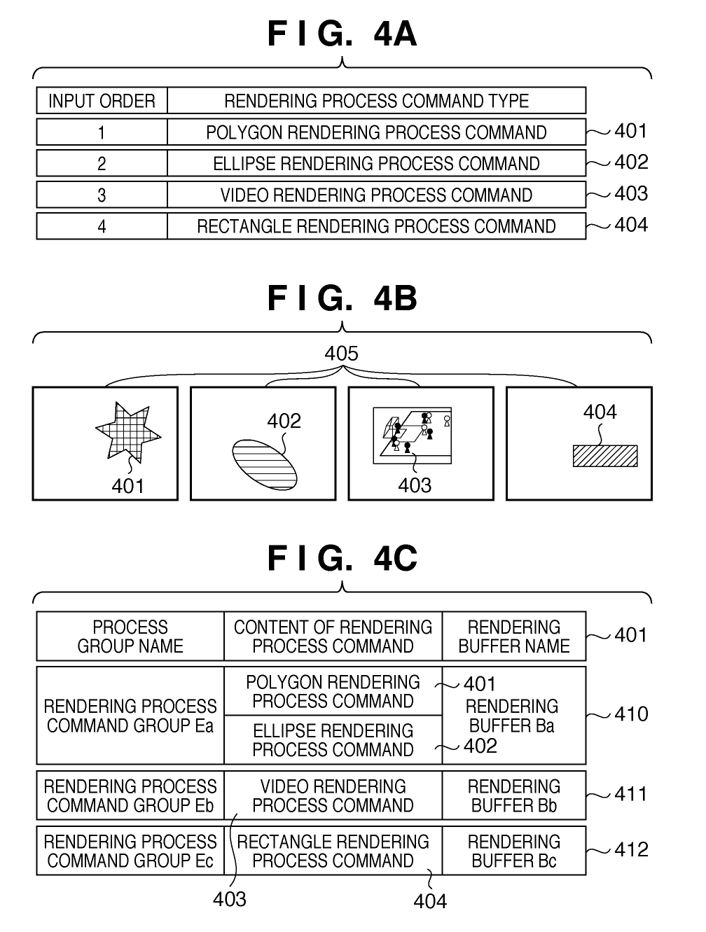

First, rendering process commands are received (step S301). FIGS. 4A, 4B and 4C are schematic diagrams explaining inputted rendering process commands and their corresponding processes. FIG. 4A shows an exemplary sequence of rendering process commands.

In the example of FIG. 4A, a polygon rendering process command 401, an ellipse rendering process command 402, a video (moving image) rendering process command 403, and a rectangle rendering process command 404 are called in sequence. Rendering contents where each of the rendering process commands are performed, will result in images shown in FIG. 4B. Note that these rendering commands can include animation that changes with time.

Next, each of the rendering process commands is categorized, and the rendering process command groups are played back (step S302). In this process, since the priority of the video rendering process command is set high, groups are divided before and after the video rendering command. In other words, the series of rendering commands prior to the video rendering command are categorized into one group, and the series of rendering process commands following the video rendering process command is categorized into another group. Subsequently, each group is set as a single unit of rendering process command. Note that the rendering processing device has a priority storage unit (not shown) which stores the priority assigned to each type of rendering process command, and priority determination process is performed which determines priorities of the categorized rendering process command groups.

More specifically, as shown in FIG. 4C, the polygon rendering process command 401 and the ellipse rendering process command 402 are grouped together and becomes a rendering process command group Ea. Next, the video rendering process command 403 becomes a rendering process command group Eb. Subsequently, the rectangle rendering process command 404, which comes after the video rendering process command 403, becomes a rendering process command group Ec.

Next, for each of the rendering process command groups, a rendering buffer is secured in the RAM 104 (step S303). In FIG. 4C, the rendering process command groups Ea, Eb and Ec are respectively given rendering buffers Ba 410, Bb 411 and Bc 412.

Next, a target frame rate is set (step S304). For example, frame rate is set in order to display, without occurrence of “drop frames”, the images which are rendered according to the priorities assigned to rendering process command groups. In this example, since the priority of the video rendering process command is high, the frame rate of the video is set as the target frame rate in order to display, without occurrence of “drop frame”, the video rendered by the rendering process command group Eb which includes the video rendering process command 403.

Next, each rendering process command group is initiated (step S305). Here, each rendering process command group is treated as a separate thread, and an assignment process of assigning computation resources for performing the rendering process command for each thread is executed. In the present embodiment, the CPU time is finely divided up and assigned to each of the threads. With this, each rendering process command group is executed in parallel, and the resulting images, generated from rendering processes performed based on rendering process commands included in rendering process command groups, are stored in the rendering buffers.

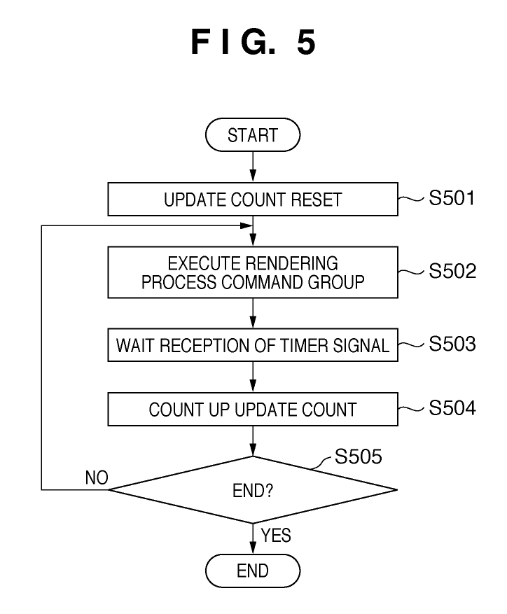

At this point, the processes individually executed by each of the rendering process command groups will be explained with reference to FIG. 5. FIG. 5 is a flowchart indicating a flow of a series of processes in groups of individual rendering process command.

First, the update count of a rendering process command group to be processed is reset (cleared) to 0 (step S501). Next, the rendering process command group is executed, and renders to the corresponding rendering buffer (step S502). In other words, the image being drawn by the rendering process commands are stored in their corresponding rendering buffers. Next, reception of a timer signal is waited for (step S503). The timer signal mentioned here is a signal transmitted at predetermined intervals based on the target frame rate determined at step S304. The rendering processing device 200 has a timing device (not shown) which keeps time and generates timer signals, and each of the rendering process command groups receives time signals from this timing device.

Subsequently, 1 is added to the update count (step S504). Then the process of steps S502 to S504 is repeated until a signal to stop and terminate the rendering process command group execution is sent (step S505). The above process is performed for each of the rendering process command groups in parallel and asynchronously.

We will return to explanation of FIG. 3. When the initiation of each rendering process command group in step S305 is completed, the initial value of the CPU time assignment for each of the rendering process command group is determined (step S306). At this step, CPU times are assigned evenly to all rendering process command groups as an initializing process.

Next, rendering buffers corresponding to each rendering process command group are composited (step S307). In other words, images stored in rendering buffers Ba 401, Bb 411 and Bc 412 are composited sequentially. Then the composited result is stored in the RAM 104.

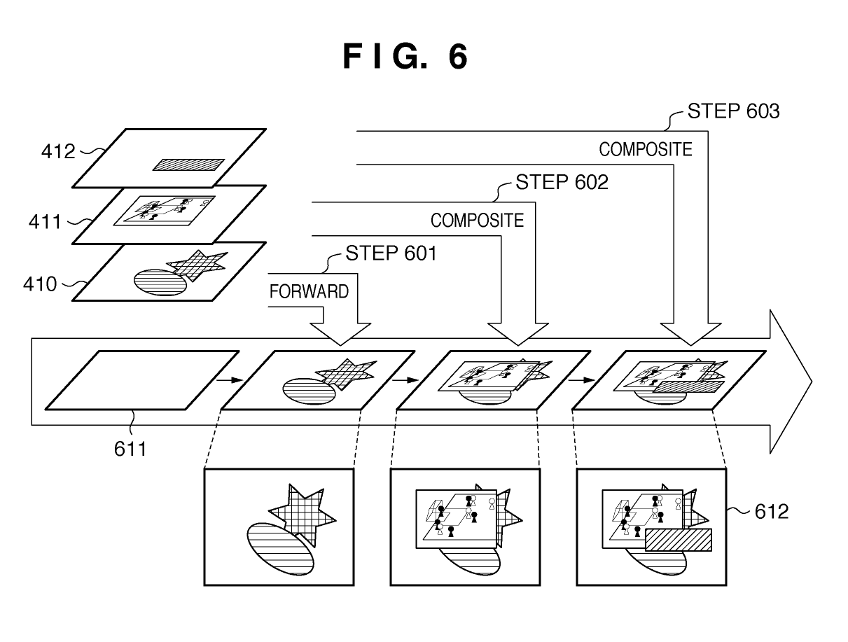

Details of the composite of rendering buffers will be explained with reference to FIG. 6. FIG. 6 is a schematic diagram indicating the procedure of compositing rendering buffers.

First, an output buffer 611 for storage of the composited result is secured in the RAM 104, and the content (image) of the rendering buffer Ba 410 is forwarded and copied to the output buffer 611 (step S601). Next, the content (image) of the rendering buffer Bb 411 is composited on top of the output buffer 611 (step S602). Then, the content (image) of the rendering buffer Bb 412 is composited on top of the output buffer 611 (step S603). By performing these processes, the frame composite result 612 for output of 1 frame is obtained.

We will return to explanation of FIG. 3. When the compositing of rendering buffers at step S307 is completed, a timer signal is waited for (step S308). The timer signal here refers to a signal generated at fixed intervals based on the target frame rate determined at step S304. When the timer signal is received at step S308, the composite result is outputted to the composite result output unit 207 (step S309).

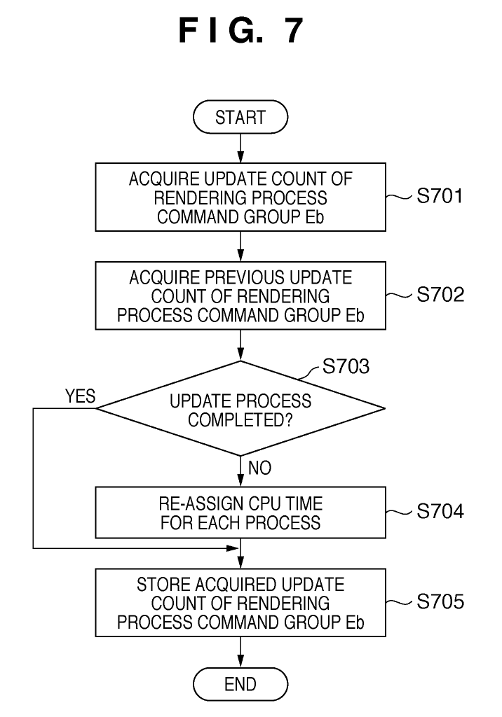

Next, CPU time to be assigned to each of the rendering process command groups is calculated (step S310). From hereon, the assignment method of CPU time to rendering process command groups will be explained according to the flowchart shown in FIG. 7. FIG. 7 is a flowchart showing a flow of process assigning CPU time to rendering process command units. In this case, since the priority assigned to the rendering process command group Eb is high, calculation of the CPU time to be assigned to the rendering process command group Eb will be explained.

First, the update count of the rendering process command group Eb stored in the RAM 104 is acquired at steps S501 and S504 of the flow chart in FIG. 5 (steps S701).

Next, the update count of the rendering process command group Eb when the previous round of CPU time assignment determining process was performed (step S308) is acquired (step S702). If the process of step S308 was the first time, the acquired value is 0.

Next, it is judged whether or not the update process of the rendering process command group Eb has been completed by comparing the values acquired from steps S701 and S702 (S703). In other words, if the value acquired in step S701 is higher than the value acquired in step S702, the update count has changed, in which case the update process of the rendering process command group Eb will be judged to have completed. On the other hand, if both values are identical, there has been no change in the update count, in which case the update process of the rendering process command group Eb will be judged as incomplete.

Note that, as shown in FIG. 5, the count-up (S504) of the update count is performed after reception of the time signal following execution of rendering process command groups (S502, S503). On the other hand, the process of FIG. 7 (S310 of FIG. 3) is also performed at the same time as the timer signal (S308). Accordingly, incomplete update process in step S703 indicates that the rendering process command groups are not executed in sync with the timer signals, i.e. the frame rate provided in each rendering process command included in the rendering process command group. For this reason, in this embodiment, when rendering process command groups could not be executed and images could not be played back according to the frame rate, an update process of the CPU time assignment for each of the rendering process command groups will be performed accordingly. With this, it is possible to optimize the CPU time assignment.

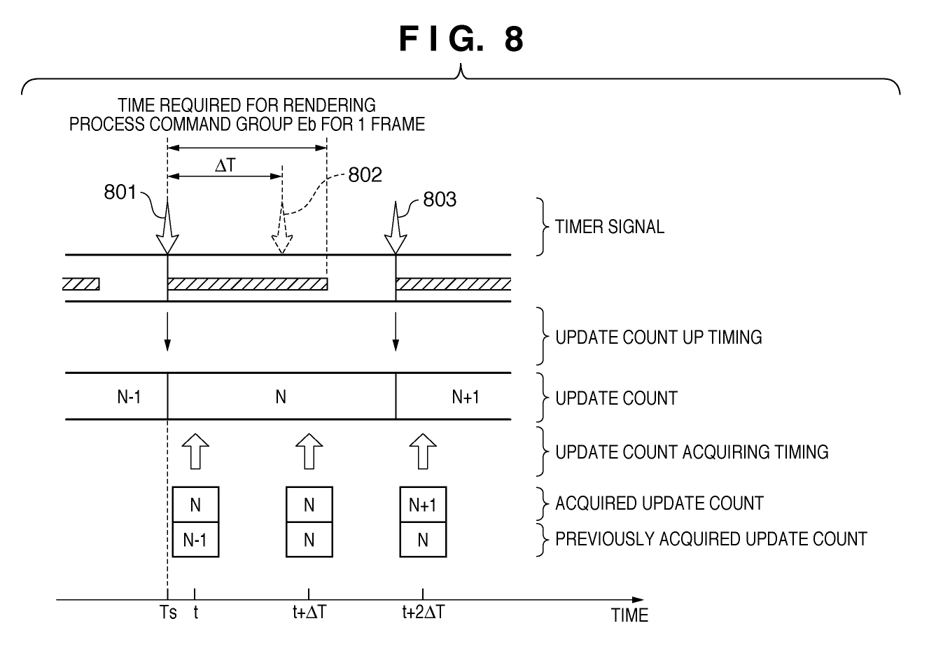

FIG. 8 is a schematic diagram explaining the processes taking place in steps S701 to S703 shown in FIG. 7. The rendering process command group Eb receives timer signals at intervals of ΔT. The processing time required for the rendering process command group Eb to perform rendering of a single frame is termed T. T is obtained by dividing the time J, consumed by the CPU for the redering process command group Eb, by the CPU utilization rate R. A case will be explained where 2ΔT≧T>ΔT.

First, the rendering process command group Eb receives signal 801 and executes the rendering process command group. Signal 802 at this time is ignored since the rendering process command group is being executed. When signal 803 is received, the execution of the rendering process command group has ended, adding 1 to the update count which makes it N+1 (S504 of FIG. 5).

On the other hand, the determination process of CPU time assignment at step S301 is synchronized with the timer signal received at step S308 and performed, where the interval is ΔT. The time when the signal 801 is generated is termed Ts, and the time when update count acquisition is performed is termed t (Ts<t<Ts+ΔT).

For example, in FIG. 8, the update count acquired at time t is N, and the previously acquired count value is N−1. For this reason, it is determined at step S703 that the update process of the rendering process command group Eb has completed.

Further, in FIG. 8, the acquired update count at t+ΔT is N, which is identical to the previously obtained update count. For this reason, it is determined at step S703 that the update process of the rendering process command group Eb has not been completed. Note that if T<ΔT the update process of the rendering process command group Eb will have completed every time the update count is acquired.

Returning to FIG. 7, when it is determined that the update process of the rendering process command group Eb has not been completed at step S703 (NO at step S703), the process moves to S704. Otherwise (YES at step S703), the process moves to S705.

At step S704, the CPU time assignment for the rendering process command group Eb is increased, and assignment of the CPU utilization ratio for each of the rendering process command groups is performed again.

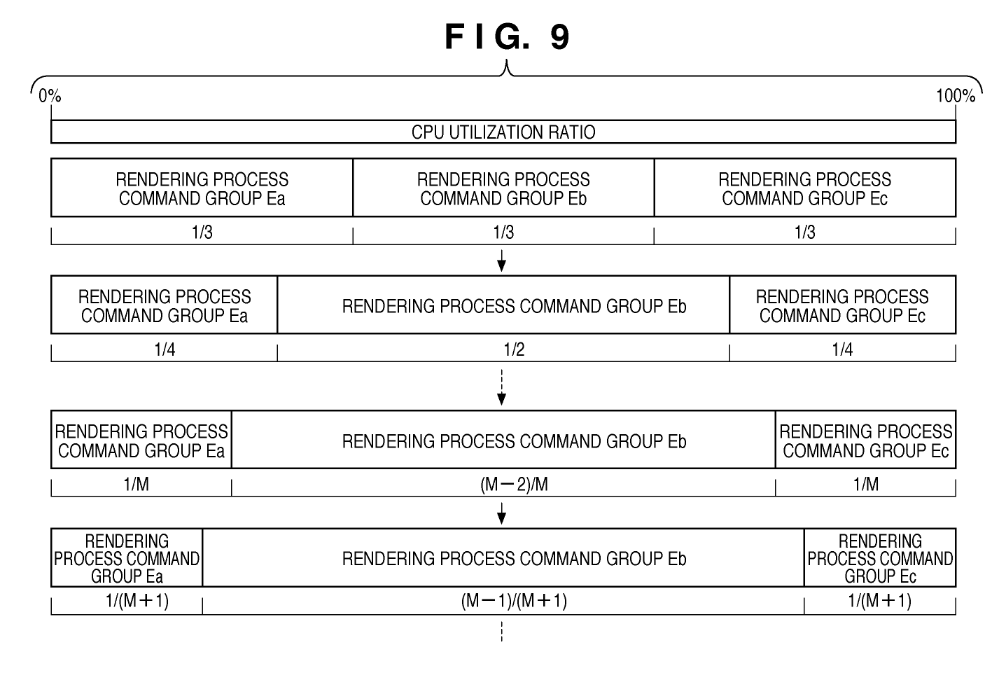

FIG. 9 is a schematic diagram explaining a method of increasing assignment of CPU utilization. In the initial exemplary condition in FIG. 9, three rendering process command groups are equally assigned, and the CPU utilization ratio for each of the rendering process command groups is ⅓. In this case, in step S704, the CPU utilization rate for the rendering process command groups Ea and Eb are reduced to ¼, and that for the rendering process command group Eb is set to ½.

After the second round, when it is determined again that the update process has not been completed at step S703, the CPU utilization rate of the rendering process command group Eb is further increased. At the time of the judgment at S703, the CPU utilization rates of the rendering process command groups Ea and Ec are 1/M, and the CPU utilization rate of the rendering process command group Eb is (M−2)/M. In this case, the CPU utilization rates are changed to 1/(M+1) for the rendering process command groups Ea and Ec, and (M−1)/(M+1) for the rendering process command group Eb.

When the time consumed for processing the rendering of a single frame by the rendering process command group Eb is defined as T, the time consumed for the rendering process command group Eb by the CPU as J, and the CPU utilization rate for the rendering process command group Eb as R, the relationship between the three variables is J=T×R, where J does not change or is nearly constant. In such a case, it is possible to reduce T by increasing the CPU utilization rate.

Note that the method of updating the assignment of the CPU times is not limited to the example shown above. For example, when it is required to increase the CPU times, it is also possible to increase the CPU times each by a certain ratio (for example 10%).

Next, the update count of the rendering process command group Eb acquired at step 701 is stored, and the process of step S301 is terminated. The processes of step S307 to S310 are repeated until the termination process of the program is performed.

As shown above, the arrangement of the present embodiment assigns computation resources for performing rendering process for each of the rendering process command groups according to their priorities. For this reason, even when the computation resources are limited, it is possible to prevent “drop frame” of the image with a high priority rendering process command, allowing high quality rendering process. Accordingly, it is possible to display the video without occurrence of any “drop frames”.

Additionally, in the present embodiment, rendering process commands are categorized into a plurality of rendering process command groups, and computation resources are assigned to each of the rendering process command groups according to their priorities for performing the rendering process. For this reason, when graphics and moving image co-existing in a single content are to be rendered, even if the rendering process commands are sequentially inputted as a series for each frame and the rendering process is to follow the sequence of the input, it is possible to perform high quality rendering process.

Note that it is also possible to perform rendering process without categorizing rendering process commands into rendering process command groups and simply assign computation resources to each rendering process command according to their priorities. In such a case, even when the computation resources are limited, it is possible to prevent “drop frames” in the image with a high priority rendering process command, and perform high quality image process.

Further, the present invention categorizes successive and more than 1 of the rendering process commands into a single rendering process command group. For this reason, it is possible to conserve the rendering process order.

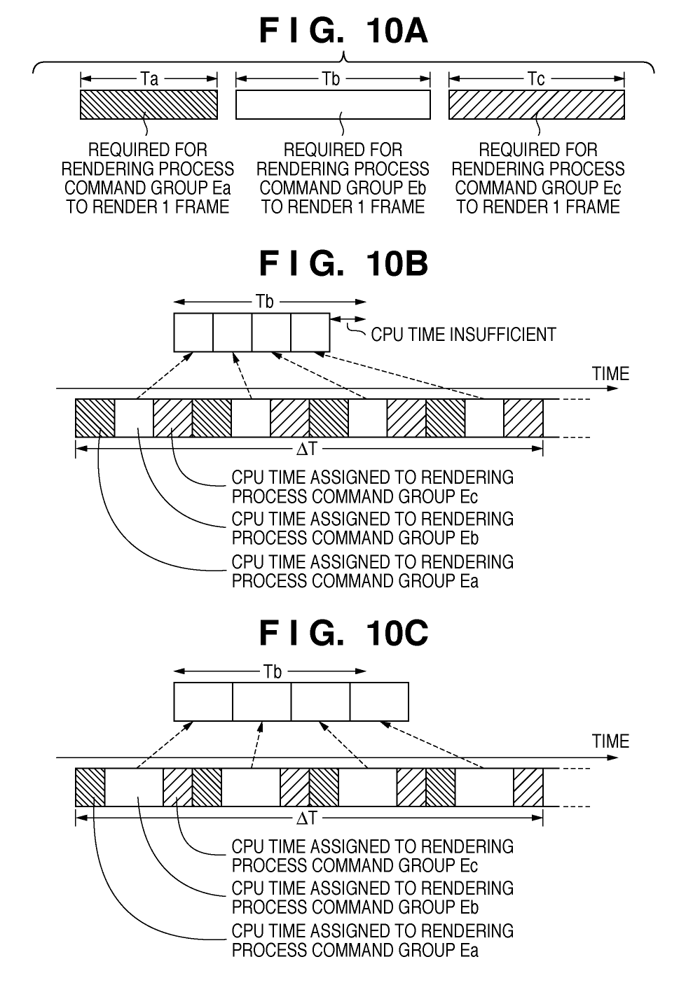

The effect of the above-mentioned arrangement will be explained with reference to FIGS. 10A, 10B and 10C. FIGS. 10A, 10B and 10C are schematic diagrams explaining the effect according to the composition of the present embodiment.

In FIG. 10A, the time required by the rendering process command group Ea for completion of rendering of a single frame is termed Ta. Similarly, the time required by the rendering process command group Eb for completion of rendering a single frame is termed Tv, and the time required by the rendering process command group Ec for completion of rendering a single frame is termed Tb. If the time for a single frame determined from the target frame rate set at step S304 is ΔT and when ΔT<Ta+Tv+Tb, it is not possible to complete all rendering process command groups within the time period of ΔT.

FIG. 10B shows time-division of time ΔT and evenly assigning to each of the processes in the above-mentioned situation. As shown in FIG. 10B, when the sum of the time-divided CPU time assigned to the rendering process command group Ea is smaller than Tv, the process will not complete within ΔT. On the other hand, the collection of CPU times assigned to groups with lower priority order, such as the rendering process command group Ea, will be bigger than Ta.

Change in the assignment of the CPU time in such a situation is illustrated in the schematic diagram shown in FIG. 10C. For example, even when the CPU time assigned to the rendering process command group Ea is collected, it will be smaller than Ta, and the process will not complete within ΔT. However, when the CPU time assigned to the high-priority rendering process command group Eb is gathered, it becomes larger than Tv, making it possible to complete the process within ΔT.

Note that the present embodiment explains a method in which a longer CPU time is assigned to the video rendering process command by setting its priority higher than other inputted rendering process commands, including a plurality of graphics rendering commands. However, the type of rendering process commands and the order of priority are not limited to what was explained in the present embodiment. For example, all inputted rendering process commands can be graphics rendering process commands, and one of them can be the high-priority rendering command. Further, all inputted rendering process commands can be video rendering process commands, and one of them can be the high-priority rendering process command.

Furthermore, the present embodiment explains a case where only one high-priority rendering process command is included in the inputted rendering process commands. However, a plurality of high-priority rendering process commands can also be included, and more detailed priorities can also be assigned.

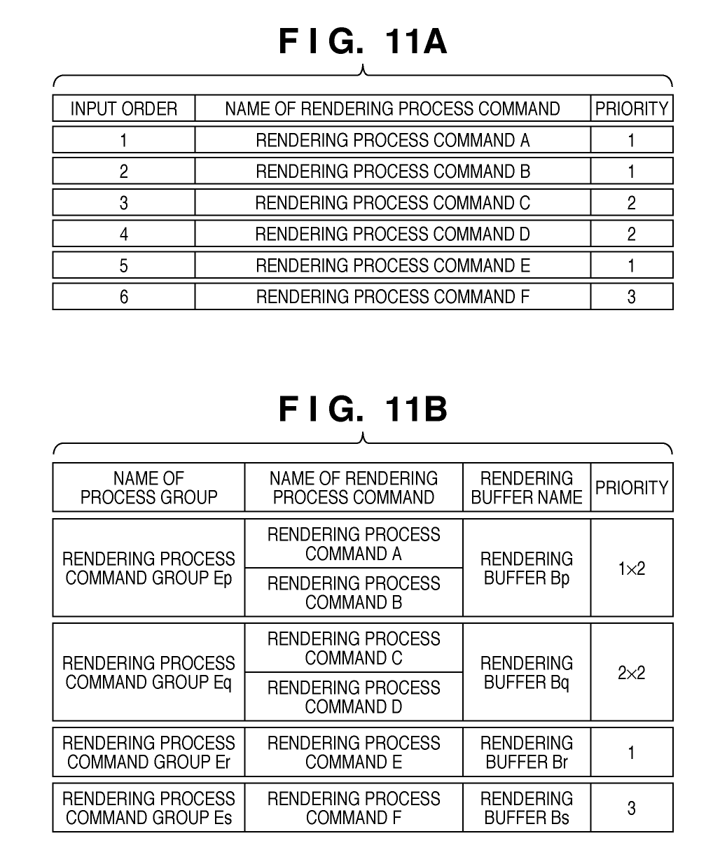

FIG. 11A is a schematic diagram illustrating input of rendering process commands each assigned with its priority at various steps in the order of rendering process command A, rendering process command B, rendering process command C, rendering process command D, rendering process command E, and rendering process command F. In this example, the higher the numerical value of priority (priority value), the higher the priority of the command.

The rendering process commands inputted in FIG. 11A are categorized into successive rendering process commands which have identical priorities. The result of categorization is as shown in FIG. 11B. In other words, the rendering process commands A and B both have priority values of 1, and are categorized together as a rendering process command group Ep since they were successively inputted. The rendering process commands C and D both have priority values of 2 and are inputted successively, hence are classified into a rendering process command group Eq. The rendering process command E becomes a rendering process command group Er by itself, and the rendering process command F becomes a rendering process group Es also by itself.

Further, rendering buffers are secured in RAM 104 for each of the rendering process command groups. Particularly, rendering buffers Bp, Bq, Br and Bs are secured.

Additionally, the priority of each rendering process command group is set as the sum of the priorities included in each rendering process command group. Accordingly, the priority assigned to the rendering process command group Ep is 1×2=2, the priority assigned to the rendering process command group Eq is 2×2=4, the priority assigned to the rendering process command group Er is 1, and the priority assigned to the rendering process command group Es is 3.

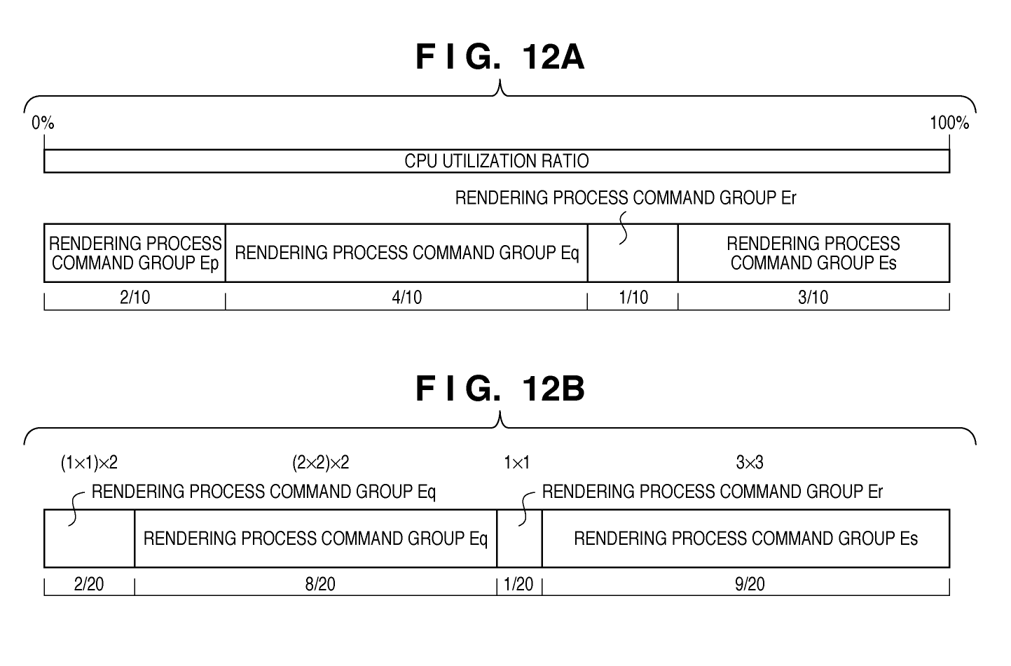

During the CPU time assignment determining process (step S310) for each of the rendering process command groups in FIG. 3, initial assignment is made according to the ratio of the priority values of the rendering process command groups. For example, the CPU time assigned to the rendering process command group Ep is 2/10^{th} of the total CPU time, and those of the rendering process command group Eq, Er and Es are respectively 4/10^{th}, 1/10^{th}, and 3/10^{th} of the total CPU time. FIG. 12A illustrates such a situation.

When the single-frame rendering process of the high-priority rendering process command group Es cannot be completed within the rendering process time, re-assignment of the CPU time is performed. In such a case, squares the priority values (i.e. raised to the power of 2) will be used as the ratios for the CPU time assignment for each of the rendering process command groups.

In the above example, the priorities of the rendering process commands A and B are set to 1²=1, and the priority of the rendering process command group Ep to 1²×2=2. Similarly, the priorities of the rendering process commands C and D are set to 2²=4, and the priority of the rendering process command group Eq to 2²×2=8. The priority of the rendering process command E is set to 1²=1, and the priority of the rendering process command group Er set to 1²=1. The priority of the rendering process command F is set to 3²=9, and the priority of the rendering process command group Es set to 3²=9.

According to this, the CPU times assigned to rendering process command groups Ep, Eq, Er, and Es are respectively 2/20^{th}, 8/20^{th}, 1/20^{th}, and 9/20^{th} of the total CPU time. FIG. 12B shows such a situation. With this, it is possible to perform the high-priority rendering process at the desired frame rate without occurrence of “drop frames”.

### Other Embodiment

Note that in the above embodiment, when rendering process command groups could not be performed according to the frame rate following initiation of the process, it is possible to either update the CPU time assignment according to the priorities, or just assign these CPU times from the beginning. For example, it is possible to increase the CPU time assignment corresponding to rendering process commands or rendering process command groups from the very beginning.

Thus far, an embodiment of the present invention was explained in detail. The present invention, however can also be implemented in various embodiments such as a system, a device, a method, a program or a storage medium. Particularly, it is possible to implement the invention as a system comprised of a plurality of instruments. Further, it can be implemented as a device comprised of a single instrument.

The objective of the invention can also be accomplished by supplying a program which can implement the functions of the above-discussed embodiment to a system or a device either directly or remotely, and reading out and executing the program code supplied to the computers of the system or the device.

Accordingly, the program code itself which needs to be installed in the computers, in order to implement the functional process of the present invention in a computer, is also included within the scope of the invention. In other words, the present invention includes computer programs for implementing the functional process of the present invention.

In such a case, if having program functions, the present invention can be in various formats such as an object code, a program executed by an interpreter, or a script data supplied to an operating system.

The storage medium for supplying the program includes media such as: flexible disc, hard disc, optical disc, magnetooptical disc, MO, CD-ROM, CD-R, CD-RW, magnetic tape, nonvolatile memory card, ROM, DVD (DVD-ROM, DVD-R).

Aside from these, as ways of program supply, the following can be considered. It is possible to use a browser in a client's device to access a website on the internet, and download a computer program or a compressed file of the present invention having a function of automatically installing itself to a storage medium such as a hard disc. Further, it is also possible to divide up the program codes comprising the program of the present invention into a plurality of files, and have each downloaded from a different website. In other words, the WWW server which makes the user download the program files for implementing the functional process of the present invention in a computer, is also included in the scope of the present invention.

Further, the following supply format can also be thought of. First, the program of the present invention is encrypted and stored in a storage medium such as a CD-ROM and distributed to users. For users that cleared a certain number of criteria, a key information is downloaded via the internet which decrypts the program encryption. Using this key information the encrypted program is executed and installed in the computer, realizing the arrangement of the present invention. Such supply format is also possible.

Further, in addition to realizing the functions of the above-discussed embodiment by the computer implementing the program, an additional embodiment can be thought of as follows. Based on the instructions by the program, the operating system and such can perform a part of or the entire process, and such process may also realize the functions of the above-discussed embodiment.

Furthermore, the functions of the above-discussed embodiment can be realized by having the program read out from the storage medium written into the memory provided at a functional expansion board inserted into the computer or a functional expansion unit or inserted into the computer, and following the instructions from this program. In other words, the components such as CPUs that are included in the functional expansion board and the functional expansion unit can perform the process partly or entirely, and the function of the above-discussed embodiment can also be realized by such process.

As discussed, according to the rendering processing device 200, when a series of rendering process commands are inputted the rendering processes are performed sequentially, it is possible to display high quality animations and moving images by preventing “drop frames” during the rendering process of the animations and moving images.

Therefore, the present invention is capable of providing a technique which enables high quality rendering process by preventing “drop frames” in images with high priority, even when the computation resources are limited.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims he benefit of Japanese Patent Application No. 2007-244446, filed on Sep. 20, 2007, which is hereby incorporated by reference herein in its entirety.

What is claimed is:

1. A rendering processing device which performs rendering processes of a plurality of inputted rendering process commands, comprising:
a categorizing unit adapted to categorize the plurality of rendering process commands into a plurality of rendering command groups;
an assigning unit adapted to assign computation resources in order to execute rendering process commands for each of the plurality of rendering command groups;
a generation unit adapted to generate images by performing rendering processes based on the rendering process commands included in the rendering command groups, using the computation resources assigned by the assigning unit;
a storage unit adapted to store the images generated by the generation unit for each of the plurality of rendering command groups in a memory; and
a compositing unit adapted to composite the images stored in the memory for each of the rendering command groups,
wherein the assigning unit assigns more computational resources to the rendering command group with higher priority.

2. The rendering processing device according to claim 1 further comprising:
an update unit adapted to update assignment of computation resources assigned to the plurality of rendering command groups when the generation unit fails to generate images according to the frame rate provided in each of the rendering process commands included in the rendering command group.

3. The rendering processing device according to claim 1 wherein the categorizing unit categorizes successive and more than one of the rendering process commands into one rendering command group.

4. The rendering processing device according to claim 3 wherein the categorizing unit categorizes the rendering process commands having the same priority into the same rendering command group.

5. The rendering processing device according to claim 1 wherein the plurality of rendering process commands includes at least one of: graphics rendering command which renders graphics, moving image rendering command which renders moving images, and still image rendering process command which renders still images.

6. The rendering processing device according to claim 5 wherein the polygon rendering process command includes an animation process which changes the graphics with time.

7. The rendering processing device according to claim 1 wherein the plurality of rendering process commands include a moving image rendering command which renders moving images, and the priority of the rendering group containing the moving image rendering process command is higher than any other rendering command group priorities.

8. The rendering processing device of claim 1 further comprising:
a priority storage unit adapted to store priorities for each type of the rendering process commands; and
a priority determination unit adapted to determine priorities of the rendering command groups categorized by the categorization unit, based on the priorities stored in the priority storage unit;
wherein the assigning unit assigns the computational resources based on the priorities of the rendering command groups determined by the determination unit.

9. A rendering processing device which performs rendering processes of a plurality of inputted rendering process commands, comprising:
an assigning unit adapted to assign computation resources to each of the plurality of rendering process commands in order to execute rendering process commands;
a generation unit adapted to generate images by performing rendering processes based on the rendering process commands, using the computation resources assigned by the assigning unit;
a storage unit adapted to store the images generated by the generation unit for each of the plurality of rendering process commands in a memory unit; and
a compositing unit adapted to composite the images stored in the memory unit for each of the rendering process commands,
wherein the assigning unit assigns more computational resources to the rendering process command with higher priority.

10. A rendering processing method of a rendering processing device which performs rendering processes of a plurality of inputted rendering process commands, comprising the steps of:
categorizing the plurality of rendering process commands into a plurality of rendering command groups;
assigning computation resources in order to execute rendering process commands for each of the plurality of rendering command groups;
generating images by performing rendering processes based on the rendering process commands included in the rendering command groups, using the computation resources assigned in the step of assigning;
storing the images generated in the step of generating for each of the plurality of rendering command groups in a memory unit; and
compositing the images stored in the memory unit for each of the rendering command groups,
wherein more computational resources are assigned to the rendering command group with higher priority in the step of assigning.

11. A program stored in a computer-readable storage medium in order to have a computer function as the rendering processing device according to claim 1.

12. The computer-readable storage medium which stores the program according to claim 11.
